(19) United States
(12) Patent Application Publication
(10) Pub. No.: US 2007/0118401 A1
(43) Pub. Date: May 24, 2007

(54) System and method for real-time healthcare business decision support through intelligent data aggregation and data modeling

(75) Inventors: Prakash Mahesh, Hoffman Estates, IL (US); Mark M. Morita, Arlington Heights, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/297,887

(22) Filed: Dec. 7, 2005

Related U.S. Application Data
(60) Provisional application No. 60/739,592, filed on Nov. 23, 2005.

(51) Int. Cl. G06Q 10/00

(52) U.S. Cl. 705/2

(57) ABSTRACT

Certain embodiments of the present invention provide a real-time healthcare business decision support system including a plurality of information sources, a processing component, and a user interface component. Each information source includes resource information for a resource in a healthcare environment. The healthcare environment includes a plurality of resources. The processing component aggregates resource information from the plurality of information sources. The processing component is capable of generating performance information based at least in part on the aggregated resource information in substantially real-time. The performance information corresponds at least in part to the performance of at least one of the plurality of resources. The user interface component is capable of displaying the performance information.

### RELATED APPLICATION

The present application claims priority to U.S. Provisional Application No. 60/739,592, filed Nov. 23, 2005, entitled “System and Method for Real-Time Healthcare Business Decision Support Through Intelligent Data Aggregation and Data Modeling,” which is herein incorporated by reference in its entirety.

### FEDERALLY SPONSORED RESEARCH OR DEVELOPMENT

[Not Apllicable]

### MICROFICHE/COPYRIGHT REFERENCE

[Not Applicable]

### BACKGROUND OF THE INVENTION

The present invention generally relates to healthcare business decision support. More specifically, the present invention relates to systems and methods for real-time healthcare business decision support through intelligent data aggregation and data modeling.

Hospitals and other medical facilities, such as, imaging centers and clinics, continually seek to improve or optimize utilization of resources and productivity. Parameters such as patient wait times and procedure turn-around times may be used to measure such optimizations. Resources may include, for example, imaging rooms, acquisition modalities, nurses, patients, radiologists, cardiologists, and transcriptionists. For example, a patient that has an excessive waiting time may leave or become irritated, resulting in sub-optimal patient satisfaction. As another example, if procedure turn-around times are not optimized, resources will be underutilized, resulting in reduced productivity because, for example, a resource such as an imaging room may sit idle when the imaging room could be used to provide services to another patient.

Another important parameter used to measure efficiency and to make business decisions is performance of a resource measured with respect to the income generated by the activity. One common economic performance metric is relative value units (RVUs). RVUs are standard units set by, for example, companies in the healthcare industry, that represent the financial value of a particular activity. RVUs may be based, at least in part, on the amount of money an insurance company will reimburse for a particular procedure, for example. For example, a computed tomography (CT) exam for a chest may be reimbursed at $5000 and have an RVU of 50. As another example, the value of the exams read by a radiologist may be expressed in RVU. Different exams may have different RVUs assigned, and the total reimbursement from an insurance company due to a radiologists readings man be represented by the sum of the RVUs for the exams read. The efficiency or performance, in terms of reimbursements generated, of radiologists may then be compared. Thus, RVU may serve as a measure of performance for a resource.

Many techniques are currently used to optimize parameters such as patient wait time and procedure turn-around time in a medical facility. For example, static reports may be created from medical information systems such as a Radiology Information System (RIS), Cardiovascular Information System (CVIS), Clinical Information System (CIS), Hospital Information System (HIS), Picture Archiving and Communication System (PACS), and/or other information or management system. Also, workflow rules may be created that provide for records and studies to be pre-fetched and for patient movements to be monitored. However, current systems and methods rely on multiple data sources. Information regarding resources must be compiled from different locations and systems. Such a process is time consuming and error prone and may be difficult to automate.

In addition, current systems and methods are static in nature. In other words, these approaches do not take all of the details of a specific situation into account. Instead, these systems and methods define a fixed set of rules to be followed that attempts to improve performance in general or on average.

Another problem with current optimization systems and methods is that they are done after the fact. That is, reports are run on past data to aid in improving and/or optimizing future situations. Workflow rules are similarly developed. Such approaches do nothing to improve the care provided to current patients or enhance current productivity. Rather, benefits are realized only after another iteration of optimization.

Current systems do not provide a way to visualize performance data and other parameters important to making business decisions. Although the information may exist in disparate systems, as discussed above retrieval, compilation, and aggregation of such data is time consuming and error prone and difficult to automate. In addition, current systems do not provide any means to visualize the data.

Current systems do not permit forecasting of, for example, future needs and the effects of new or different resources on performance and efficiency. Administrators are left to make blind decisions without hard data to substantiate their decisions. For example, current systems do not allow an facility administrator to forecast or model the effect of acquiring an new imaging modality on based on past, current, and projected future demands.

Thus, a need exists for a system and method for real-time healthcare business decision support. Such a system and method may provide automated and/or integrated access to resource information contained in one or more information sources. In addition, such a system allows real-time monitoring and improvement of workflow, so that utilization of resources is improved immediately, rather than only improving utilization for future cases. Further, such a system allows forecasting and modeling of potential workflow changes based on past, current, and projected data.

### BRIEF SUMMARY OF THE INVENTION

Certain embodiments of the present invention provide a real-time healthcare business decision support system including a plurality of information sources, a processing component, and a user interface component. Each information source includes resource information for a resource in a healthcare environment. The healthcare environment includes a plurality of resources. The processing component aggregates resource information from the plurality of information sources. The processing component is capable of generating performance information based at least in part on the aggregated resource information in substantially real-time. The performance information corresponds at least in part to the performance of at least one of the plurality of resources. The user interface component is capable of displaying the performance information.

In an embodiment, an information source in the plurality of information sources is at least one of a database, a medical information system, and an acquisition modality. In an embodiment, the performance information includes an economic performance metric for at least one resource in the plurality of resources. In an embodiment, the economic performance metric is in relative value units (RVUs). In an embodiment, the processing component is capable of generating a recommendation based at least in part on the resource information. In an embodiment, the user interface component is capable of presenting the recommendation to a user. In an embodiment, the user interface component is capable of filtering the performance information. In an embodiment, the user interface component is capable of being configured based at least in part on user preferences. In an embodiment, the processing component is capable of creating a performance model. In an embodiment, the model is based at least in part on the resource information. In an embodiment, the model is based at least in part on past resource information. In an embodiment, the model is based at least in part on hypothetical resource information supplied by a user. In an embodiment, the processing component is capable of generating a workflow recommendation based at least in part on the model.

Certain embodiments of the present invention provide a method for real-time healthcare business decision support including aggregating resource information from a plurality of information sources, generating performance information based at least in part on the aggregated resource information, and determining a workflow recommendation based at least in part on the performance information. Each information source includes resource information for a healthcare environment. The performance information is generated in substantially real-time.

In an embodiment, the recommendation is based at least in part on past performance information. In an embodiment, the recommendation is based at least in part on resource information provided by a user. In an embodiment, the recommendation includes automatic identification of a workflow bottleneck. In an embodiment, the recommendation is based at least in part on current workflow patterns.

Certain embodiments of the present invention provide a computer-readable medium including a set of instructions for execution on a computer, the set of instructions including a resource aggregation routine and a processing routine. The resource aggregation routine is configured to aggregate resource information from a plurality of information sources. Each information source includes resource information for a resource in a healthcare environment. The processing routine is configured to generate performance information based at least in part on the aggregated resource information. The performance information is generated in substantially real-time.

Certain embodiments include a recommendation routine configured to determine a workflow recommendation based at least in part on the performance information.

### BRIEF DESCRIPTION OF SEVERAL VIEWS OF THE DRAWINGS

FIG. 1 illustrates a real-time healthcare business decision support system used in accordance with an embodiment of the present invention.

FIG. 2 illustrates an interface for a healthcare business decision support system used in accordance with an embodiment of the present invention.

FIG. 3 illustrates a flow diagram for a method for real-time medical workflow management used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

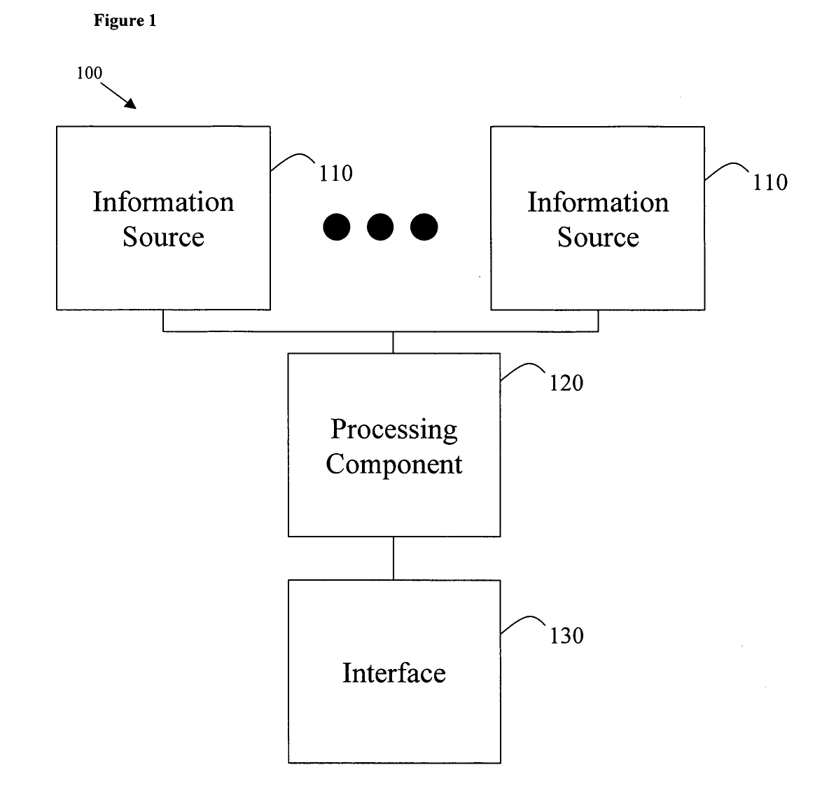

FIG. 1 illustrates a real-time healthcare business decision support system 100 used in accordance with an embodiment of the present invention. The system 100 includes a plurality of information sources 110, a processing component 120, and an interface 130.

The processing component 120 is in communication with the plurality of information sources 110. The processing component 120 is in communication with the interface 130. Communication may include wired and/or wireless communication, for example.

In operation, each information source 110 in the plurality of information sources includes resource information for at least one resource in a healthcare environment. The healthcare environment includes a plurality of resources. Resources may include, for example, imaging rooms, acquisition modalities, nurses, patients, radiologists, cardiologists, and transcriptionists.

An information source 110 may include resource information for a single resource, for example. Alternatively, an information source 110 may include, for example, resource information for a full department, part of a department, and/or multiple departments within a healthcare environment or facility. A department may be a radiology, cardiology, surgery, oncology, emergency room, pediatrics, laboratory, and/or administrative department within a hospital, clinic, or medical facility, for example.

Resource information may include, for example, patient information, patient waiting time, transcriptionist capacity, transcriptionist capability, radiologist capacity, radiologist capability, studies ordered, exams read, and/or procedure information. In this example, capacity is a number of available resources, and capability is a number of work elements the resource(s) may process in a given period of time. Alternatively, or in addition, resource information may include, for example, rooms, procedures, resource layouts, distances, metrics, nurses, computers, and/or acquisition modality status. For example, an information source 110 may contain, in part, procedures that may be performed and/or metrics, such as average procedure time, average patient waiting time, and average patient recovery room time.

In an embodiment, an information source 110 may be a database, a collection of databases, or other information repositories. An information source 110 may act as a single interface to multiple information systems and other resources, for example. That is, an information source 110 may include links or connections to other resource(s) to permit access and/or manipulation of the resource(s), for example. An information source 110 may enable access to multiple, disparate systems from a single interface, such as the interface 130. For example, an information source 110 may include links, connections, and/or content with respect to a variety of medical information systems, such as RIS, CVIS, CIS, HIS, PACS, and/or other information or management system. The resources included in the information source 110 may include information systems from multiple departments, for example.

In an embodiment, an information source 110 may be a medical information system. For example, an information source 110 may be an RIS, CVIS, CIS, HIS, and/or PACS.

In an embodiment, an information source 110 may be an acquisition modality. For example, an information source 110 may be a CT scanner or x-ray machine, for example.

The processing component 120 aggregates resource information from the plurality of information sources 110. That is, the processing component 120 receives resource information for one or more resources in the healthcare environment from one or more information sources 110. The processing component 120 may receive some or all of the resource information included in an information source 110, for example.

The processing component 120 is adapted to communicate with a variety of information sources 110. For example, the processing component may communicate with an acquisition modality, a database, and/or a medical information system.

In an embodiment, an information source 110 may be accessed when resource information is needed by the processing component 120 in a “pull” model. That is, the processing component 120 may receive resource information because the processing component 120 requested the resource information from an information source 110. In an embodiment, an information source 110 may provide resource information to the processing component 120 in a “push” model. That is, an information source 110 may send new and/or changed resource information to the processing component 120 when some event and/or change is made to the resource information.

The processing component 120 generates performance information based at least in part on the resource information received from the plurality of information sources 110. The performance information may include, for example, turnaround time, exam throughput, and/or an economic performance metric for various activities. An economic performance metric may measure performance with respect to income generated by an activity. An economic performance metric may be, for example, RVU or some other standard, custom, or user-specified metric. For example, RVU may be determined for a radiologist's unsigned exams, for one or more studies, and/or for a radiologist's total throughput. The RVU performance information for a resource may be based at least in part on the corresponding resource information for the resource, for example.

The processing component 120 generates the performance information in real-time, or substantially real-time. That is, the performance information is generated immediately, or after some delayed period of time due in part to system delay, processing delay, and/or communication lag, for example. In certain embodiments, performance information is generated at the request of a user. For example, a user may request that performance information be updated.

In an embodiment, the processing component 120 creates a performance model. The model reflects performance characteristics of one or more resources in the healthcare environment.

The model may be based at least in part on resource information received from one or more information sources 110. The model may be based at least in part on past resource information. That is, resource information previously received by the processing component 120 may be used to create the model. For example, the processing component 120 may maintain historical performance information for one or more resources. In an embodiment, the model is based at least in part on resource information supplied by a user. For example, a user may want the model to include an imaging system that is not in communication with the processing component due to its physical location. In an embodiment, the model is based at least in part on hypothetical resource information. The hypothetical resource information may be supplied by a user or analysis system, for example. For example, a user may want the model to reflect two additional imaging systems the user is considering purchasing. In an embodiment, the model may be based at least in part on current workflow patterns.

The performance model may be used to forecast and/or predict resource performance, for example. For example, the model may be used by a user to forecast turnaround time of a radiology department at various patient and/or exam loads. As another example, the model may be used to forecast acquisition modality utilization when an additional, hypothetical acquisition modality is present.

In an embodiment, the processing component 120 generates a recommendation. The recommendation may be a workflow recommendation, for example. For example, the processing component 120 may examine performance information and/or resource information and determine that another radiologist is needed based on the number of studies ordered, turnaround time, and radiologist workload. In an embodiment, the recommendation is based at least in part on resource information. In an embodiment, the recommendation is based at least in part on the performance model. In an embodiment, the recommendation is based at least in part on past resource information. In an embodiment, the recommendation is based at least in part on resource information supplied by a user.

A recommendations may, for example, suggest a utilization of resources to achieve an optimization, increase, or improvement in resource usage. For example, the processing component 120 may identify that a particular imaging facility is understaffed as indicated by, for example, relatively high performance values for the staff but underutilization of an imaging modality. In an embodiment, a recommendation may indicate a workflow bottleneck. For example, a radiologist may be sick, unread exams may increase, and a recommendation may be made for a radiologist not scheduled to work may be temporarily assigned to fill in. In an embodiment, the recommendation may be based at least in part on current workflow patterns. In an embodiment, the recommendation may be generated automatically by the processing component 120.

The processing component 120 may communicate the recommendation to the interface 130 and/or to an external system, for example.

The interface 130 may communicate some or all of the performance information received from the optimizer engine 130 to a user. The interface 130 may include a display device. For example, the display device may be one or more of a computer screen, a portable computer, a tablet computer, and a personal digital assistant (PDA). The interface 130 may include an input device. For example, the input device may include one or more of a keyboard, a touch-screen, a joystick, a mouse, a touchpad, and a microphone. The input device may use a microphone in conjunction with voice recognition software and/or hardware, for example.

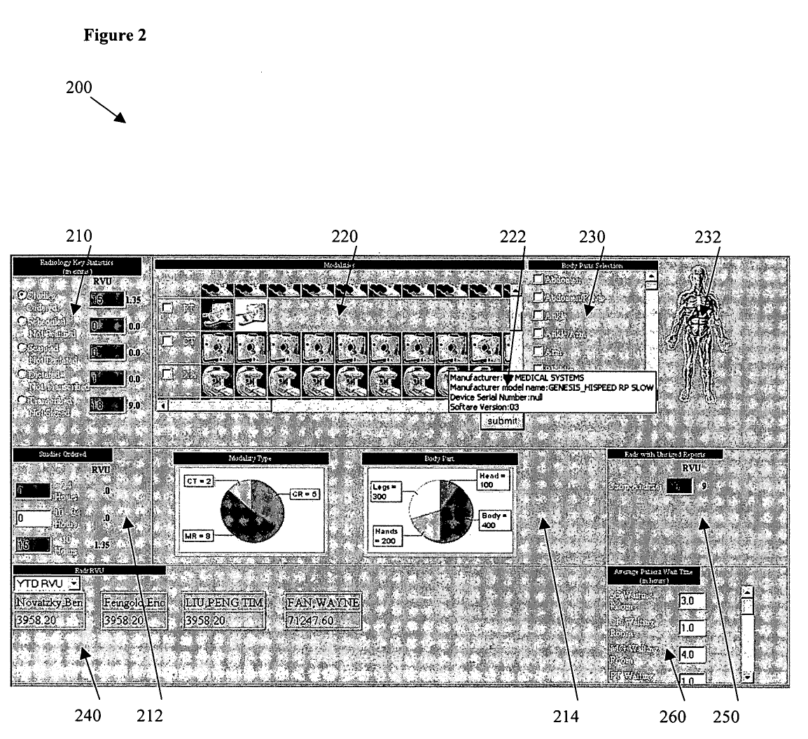

The interface 130 may display some or all of the performance information received from the processing component 120 using reports, and/or filters. A report may include, for example, patient waiting time, radiologist performance in RVU, and current imaging system utilization status. Filters may control the performance information presented by the interface 130. For example, a user may select filters in the interface 130 to limit the reporting of information to order studies. The interface 130 may then display performance information specific to the filter criteria. Continuing the last example, performance information on ordered studies may be broken down by turnaround time for ordered studies, the modality and body part involved in the study, and the RVUs of the studies ordered. The presentation of performance information by the interface 130 is discussed in more detail below with reference to FIG. 2.

In an embodiment, interface 130 is configurable. For example, a user may configure what performance information is to be displayed and how the performance information is to be visualized. Different users may be interested in performance information for different resources and/or prefer the performance information presented in different ways. For example, an administrator in charge of radiologists may be interested in different representations of performance information relating to the radiologists themselves, such as number of unsigned exams or RVU generated by each radiologist over the past year. On the other hand, an administrator for imaging systems may be interested in performance information relating to acquisition modalities, such as the current utilization status of CT scanners. In an embodiment, interface 130 is configured based at least in part on user preferences. The user preferences may reflect prior configuration of the interface 130 that persists across multiple uses by a user, for example.

In an embodiment of the present invention, the interface 130 may communicate the recommendation received from the processing component 120 to a user. The interface 130 may display a pop-up window or overlay, email or page a user, and/or generate a printed, displayed and/or transmitted report, for example.

In an embodiment, the interface 130 may be a “dashboard.” The dashboard may be a hardware device, software application, or combination of hardware and software. The dashboard may convey performance information to a user. The dashboard may convey to the user the current performance of resources. For example, the dashboard may visually indicate whether a particular acquisition modality is in use and/or operating at capacity.

The components, elements, and/or functionality of system 100 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

FIG. 2 illustrates an interface 200 for a healthcare business decision support system used in accordance with an embodiment of the present invention. Interface 200 may be similar to interface 130, described above, for example. For the purposes of the following discussion, interface 200 will be described with capabilities similar to interface 130, described above. However, it would be known to one having ordinary skill in the art that other implementations are possible.

As discussed above, interface 200 may be configured to present performance information in a variety of different ways and layouts. Performance information may be presented, for example, as text, in a table, list, chart, and/or other graphical format. In addition, interface 200 may display different performance information depending on any filters selected. It should be emphasized that the following discussion of interface 200 is as depicted in FIG. 2, but that other implementations, layouts, reports, and filters are possible and would be known to one having ordinary skill in the art.

Interface 200 includes a study report and filter 210, a study performance report 212, a study breakdown report 214, a modality report and filter 220, a modality detail 222, a body part filter 230, a graphical body part filter 232, a radiologist performance report 240, an unsigned exams report 250, and a patient wait time report 260.

In operation, the study report and filter 210 may include a report of performance information for studies. The report may be broken down by studies in various stages and performance information given for each stage, for example. Performance information may be given in RVU, for example. Studies may be in one of several stages, such as “ordered,” “schedule,” scanned,” “dictated,” and “transcribed.” The stages may be mutually exclusive. The study report and filter 210 may also be used as a filter. For example, a particular stage may be selected. Based at least in part on the selected stage in the study report and filter 210, the study performance report 212 and/or the study breakdown report 214 may reflect performance information for studies in the selected stage.

The study performance report 212 may provide performance information for studies including, for example, turn around-time and/or corresponding RVU associated with studies in each category of turn-around time. For example, studies may be broken down by turn-around times for less than 10 hours, 10 to 24 hours, and greater than 24 hours. The RVU for the exams in each category may similarly be reported. The study performance report 212 may provide performance information for studies filtered based at least in part on the selection in the study report and filter 210, for example.

The study breakdown report 214 may provide performance information for studies including, for example, modality type and/or body part. For example, studies may be broken down based on the acquisition modality and/or body part involved in the study. The study breakdown report 214 may provide performance information for studies filtered based at least in part on the selection in the study report and filter 210, for example.

The modality report and filter 220 may include a report of performance information for acquisition modalities in the healthcare environment. The modality report and filter 220 may provide performance information for one or more acquisition modalities. For example, the modality report and filter 220 may include a representation of the current use state of each modality, for example. A modality use state may be, for example, “in use,” “not in use,” and/or “use exceeds capacity.” The use state may be represented graphically and/or by a color code, for example. The modality report and filter 220 may allow performance information to be filtered based at least in part on the type of acquisition modality, for example. For example, the study performance report 212 may be limited based at least in part to studies for a selected modality type or types.

The modality detail 222 may display detailed performance information regarding a particular modality listed in the modality report and filter 220, for example. The modality detail 222 may be a pop-up dialog that displays when a user places a cursor over a particular modality. The modality detail 222 may provide performance information specific to the particular resource.

The body part filter 230 may allow performance information to be filtered based on the particular body part or set of body parts involved. For example, the studies included in the study performance report 212 may be limited based at least in part to studies for a selected body part or set of body parts, as specified by the body part filter 230. The graphical body part filter 232 may similarly allow performance information to be filtered. However, rather than selecting check boxes in the body part filter 230, a user may be able to select the desired body part(s) to filter on directly from the graphical body part filter 232. The graphical body part filter 232 may also provide a graphical representation of body part(s) being filtered as selected by the body part filter 230 using, for example, a color code to indicate selected and/or excluded body parts.

The radiologist performance report 240 may report performance information for one or more radiologist resources. For example, the performance of radiologists may be reported based on exams read or RVU of exams processed. The radiologist performance report 240 may allow performance information to be displayed based on, for example, date ranges, specific time periods, or specialties. For example, the radiologist performance report 240 may display RVU performance information for all radiologists for the year to date.

The unsigned exams report 250 may report performance information on radiologists that have unsigned exams pending. The unsigned exams report 250 may include, for example, the number of unsigned exams and/or the RVU of the unsigned exams. Filters such as the modality report and filter 220, discussed above, may affect what radiologists are included in the unsigned exams report 250, for example.

The patient wait time report 260 may display performance information related to resources such as waiting rooms or patients, for example. For example, the patient wait time report 260 may break down the average waiting time for patients based on various waiting rooms. The waiting rooms may be waiting rooms for different modalities, for example.

As discussed above, the layout and contents of the interface 200 may depend on a variety of factors such as, for example, the particular user, user preferences and/or configuration, resources in the healthcare environment, and current activity. As mentioned, interface 200 as discussed is intended only to serve as an example of how some forms of performance information may be visualized, utilized, and/or manipulated.

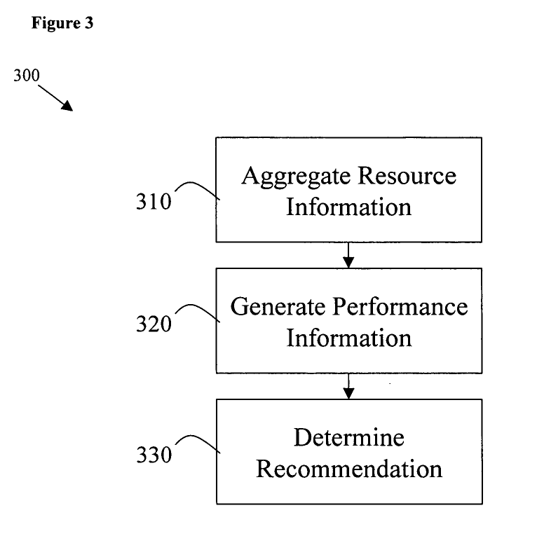

FIG. 3 illustrates a flow diagram for a method 300 for real-time medical workflow management used in accordance with an embodiment of the present invention. The method 300 includes the following steps, which will be described in more detail below. At step 310, resource information is aggregated. At step 320, performance information is generated. At step 330, a recommendation is determined. Certain embodiments of the present invention may omit one or more of these steps and/or perform the steps in a different order than the order listed, including simultaneously. The method 300 is described with reference to elements of systems described above, but it should be understood that other implementations are possible.

At step 310, resource information is aggregated. Resource information may be received from one or more information sources, similar to information source 110, described above, for example. In an embodiment, resource information is received by a processing component, similar to processing component 120, described above.

In an embodiment, an resource information may be aggregated from an information source 110 in a “pull” model. That is, the processing component 120 may receive resource information because the processing component 120 requested the resource information from an information source 110. In an embodiment, an resource information may be aggregated from an information source 110 in a “push” model. That is, an information source 11O may send new and/or changed resource information to the processing component 120 when some event and/or change is made to the resource information.

At step 320, performance information is generated. Performance information may be generated by a processing component, similar to processing component 120, described above, for example. The processing component 120 may generate performance information based at least in part on resource information. The resource information may be the resource information aggregated at step 310, described above, for example. The resource information may be received from the plurality of information sources 110. The performance information may include, for example, turnaround time, exam throughput, and/or RVU for various activities. For example, RVU may be determined for a radiologist's unsigned exams, for one or more studies, and/or for a radiologist's total throughput.

The processing component 120 may generate the performance information in real-time, or substantially real-time. That is, the performance information may be generated immediately, or after some delayed period of time due in part to system delay, processing delay, and/or communication lag, for example. In certain embodiments, performance information is generated at the request of a user. For example, a user may request that performance information be updated.

In an embodiment, the performance information may be based on a performance model. The performance model may be similar to the performance model generated by the processing component 120, described above, for example.

At step 330, a recommendation is determined. The recommendation may be a workflow recommendation, for example. The recommendation may be determined by a processing component. The processing component may be similar to processing component 120, described above, for example. For example, the processing component 120 may examine performance information and/or resource information and determine that another radiologist is necessary based on the number of studies ordered, turnaround time, and radiologist workload. In an embodiment, the recommendation is based at least in part on resource information. In an embodiment, the recommendation is based at least in part on the performance model. In an embodiment, the recommendation is based at least in part on past resource information. In an embodiment, the recommendation is based at least in part on resource information supplied by a user.

The recommendation may be presented by a computer display, a printed report, a voice message, and/or an electronic message, for example. The recommendation may be presented by an interface similar to interface 130 and/or interface 200, described above, for example.

One or more of the steps of the method 300 may be implemented alone or in combination in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or image viewer.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide automated and/or integrated access to resource information contained in one or more information sources. Certain embodiments also allow real-time monitoring and improvement of workflow. Certain embodiments allow forecasting and modeling of potential workflow changes based on past, current, and projected data.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A real-time healthcare business decision support system, the system including:
a plurality of information sources, wherein each information source includes resource information for a resource in a healthcare environment, wherein the healthcare environment includes a plurality of resources;
a processing component, wherein the processing component aggregates resource information from the plurality of information sources, wherein the processing component is capable of generating performance information based at least in part on the aggregated resource information in substantially real-time, wherein the performance information corresponds at least in part to the performance of at least one of the plurality of resources; and
a user interface component, wherein the user interface component is capable of displaying the performance information.

2. The system of claim 1, wherein an information source in the plurality of information sources is at least one of a database, a medical information system, and an acquisition modality.

3. The system of claim 1, wherein the performance information includes an economic performance metric for at least one resource in the plurality of resources.

4. The system of claim 3, wherein the economic performance metric is in relative value units (RVUs).

5. The system of claim 1, wherein the processing component is capable of generating a recommendation based at least in part on the resource information.

6. The system of claim 5, wherein the user interface component is capable of presenting the recommendation to a user.

7. The system of claim 1, wherein the user interface component is capable of filtering the performance information.

8. The system of claim 1, wherein the user interface component is capable of being configured based at least in part on user preferences.

9. The system of claim 1, wherein the processing component is capable of creating a performance model.

10. The system of claim 9, wherein the model is based at least in part on the resource information.

11. The system of claim 9, wherein the model is based at least in part on past resource information.

12. The system of claim 9, wherein the model is based at least in part on hypothetical resource information supplied by a user.

13. The system of claim 9, wherein the processing component is capable of generating a workflow recommendation based at least in part on the model.

14. A method for real-time healthcare business decision support, the method including:
aggregating resource information from a plurality of information sources, wherein each information source includes resource information for a healthcare environment;
generating performance information based at least in part on the aggregated resource information, wherein the performance information is generated in substantially real-time; and
determining a workflow recommendation based at least in part on the performance information.

15. The method of claim 14, wherein the recommendation is based at least in part on past performance information.

16. The method of claim 14, wherein the recommendation is based at least in part on resource information provided by a user.

17. The method of claim 14, wherein the recommendation includes automatic identification of a workflow bottleneck.

18. The method of claim 14, wherein the recommendation is based at least in part on current workflow patterns.

19. A computer-readable medium including a set of instructions for execution on a computer, the set of instructions including:
a resource aggregation routine configured to aggregate resource information from a plurality of information sources, wherein each information source includes resource information for a resource in a healthcare environment; and
a processing routine configured to generate performance information based at least in part on the aggregated resource information, wherein the performance information is generated in substantially real-time.

20. The set of instructions of claim 19, further including a recommendation routine configured to determine a workflow recommendation based at least in part on the performance information.
